(19) United States
(12) Patent Application Publication
(10) Pub. No.: US 2026/0368423 A1
(43) Pub. Date: Nov. 19, 2026

(54) Splitting CSV files for parallel processing

(71) Applicant: OWN DATA COMPANY LTD., Tel Aviv (IL)

(72) Inventor: Eyal Kenigsberg, Dolev (IL)

(21) Appl. No.: 19/206,095

(22) Filed: May 13, 2025

(51) Int. Cl. G06F 40/177; G06F 16/25

(52) U.S. Cl. CPC G06F 40/177; G06F 16/258

(57) ABSTRACT

A method for processing a comma-separated values (CSV) file includes identifying a number of fields in the file by reading a header row of the file, and splitting the file into a first part and one or more subsequent parts that follow the first part. The method further includes identifying respective terminating newline characters in the subsequent parts, by, for each of the subsequent parts, identifying, as the terminating newline character in the subsequent part, a newline character followed by one or more consecutive lines that each has a number of elements equal to the number of fields. The method further includes re-splitting the file, following the terminating newline characters, into multiple portions, and passing the portions to respective parallel processes. Other embodiments are also described.

### FIELD OF EMBODIMENTS OF THE DISCLOSURE

Embodiments of the present disclosure are related generally to the field of computing, and specifically to the processing of comma-separated values (CSV) files.

### BACKGROUND

CSV files are a simple, widely-used format for storing and organizing data in a tabular form. Each line in a CSV file represents a row of data, with individual values separated by commas or other delimiters. In some applications, tables in a database are backed up to CSV files.

Parallel processing is a computational technique where multiple processes or tasks are executed simultaneously, rather than sequentially. By dividing a large task into smaller sub-tasks that can run concurrently on different processors or cores, parallel processing can significantly speed up computations, especially for complex or data-heavy problems. Parallel processing can be implemented in hardware, e.g., using multi-core processors or distributed systems, and in software, e.g., through multi-threading or task-based frameworks.

### BRIEF DESCRIPTION OF THE DRAWINGS

FIG. 1 is a schematic illustration of a system for processing a comma-separated values (CSV) file, in accordance with some embodiments of the present disclosure;

FIG. 2 is a schematic illustration of a splitting of an example CSV file in accordance with some embodiments of the present disclosure; and

FIG. 3 is a flow diagram for a method for splitting a CSV file, in accordance with some embodiments of the present disclosure.

### DETAILED DESCRIPTION

### Overview

Some applications require processing a comma-separated values (CSV) file. For such applications, it is often helpful to split the CSV file into multiple smaller files, so that the smaller files can be processed in parallel. However, it may be challenging to split the CSV file so that each smaller file contains a whole number of rows. For example, although most newline characters in the CSV file may terminate the rows in the file, some newline characters may, by accident or by design, be internal to the rows. For example, some newline characters may be enclosed in quotation marks. If one of these internal newline characters is selected as a point at which to split the CSV file, the row that contains this internal newline character will be split in two.

To address this challenge, embodiments of the present disclosure provide a splitting algorithm that generally avoids mid-row splits, such that each of the smaller CSV files includes a whole number of rows. The algorithm first identifies the number of fields in the CSV file by reading the header row of the file. The algorithm then splits the file into multiple parts, which are typically of approximately equal size. Next, in each of the second through last parts, the algorithm finds a newline character – e.g., finds the first newline character – that appears to terminate a row, by virtue of being followed by at least one line whose number of elements is the same as the number of fields. The CSV file is then re-split following the identified terminating newline characters.

### System Description

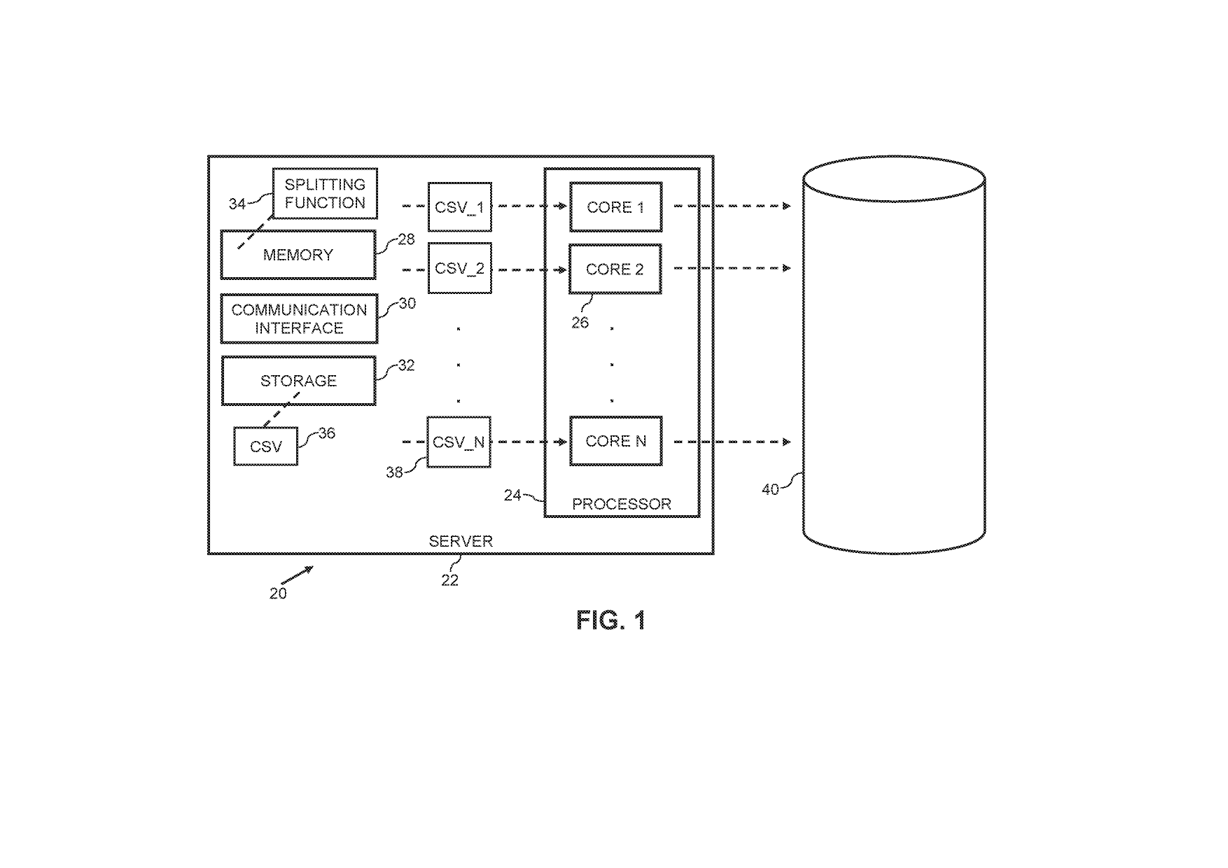

Reference is initially made to FIG. 1, which is a schematic illustration of a system 20 for processing a comma-separated values (CSV) file 36, in accordance with some embodiments of the present disclosure.

In some embodiments, system 20 comprises a computer 22, such as a server, e.g., a server on a cloud-computing platform. Computer 22 comprises a processor 24 comprising multiple cores 26, identified in FIG. 1 as CORE 1, CORE 2, … CORE N. Computer further comprises a memory 28 such as a random access memory (RAM), a communication interface 30, such as a network interface controller, and a file storage 32, such as a hard drive or solid state drive, which is configured to store CSV file 36. Memory 28 is configured to store a splitting function 34, which is written in software code. By executing splitting function 34, processor 24 splits CSV file 36 into multiple portions 38, identified in FIG. 1 as CSV_1, CSV_2, … CSV_N. Following the splitting of the CSV file, processor 24 passes portions 38 to respective parallel processes executed by cores 26.

It is noted that splitting function 34 (FIG. 1) may include any number of sub-functions, such as a first sub-function to identify the positions at which CSV file 36 is to be split, and a second sub-function to split the CSV file at these positions.

In other embodiments, system 20 comprises multiple computers configured to cooperatively perform the functionality outlined above. For example, in some embodiments, a first computer splits CSV file 36, and a second computer then processes portions 38 in parallel to each other. Alternatively, for example, a first computer identifies the positions at which CSV file 36 is to be split (by executing the first sub-function described above), a second computer splits the CSV file at these positions (by executing the second sub-function described above), and then the second computer or a third computer processes portions 38 in parallel to each other. Alternatively, for example, the parallel processing of portions 38 is performed by multiple computers.

It is noted that the number of portions 38 is not necessarily equal to the number of cores 26. For example, in some embodiments, the number of portions 38 is less than the number of cores 26. Alternatively, the number of portions 38 is greater than the number of cores 26, and at least two of the parallel processes are executed by the same core 26.

In some embodiments, the parallel processes load data in portions 38 to a database 40, which may be local to or remote from computer 22. (For embodiments in which database 40 is remote, the data is loaded via communication interface 30.) For example, in some embodiments, a table in database 40 is backed up to CSV file 36, and the loading of data to the database restores the table. Alternatively, the parallel processes perform another task such as checking for particular data in the CSV file, summing numerical data in the file, or reformatting the file.

In general, processor 24 may be embodied as a single processor, or as a cooperatively networked or clustered set of processors. Typically, processor 24 is embodied as a programmed processor comprising, for example, a central processing unit (CPU) and/or a Graphics Processing Unit (GPU). Program instructions, including software programs, and/or data may be loaded for execution and processing by the CPU and/or GPU. The program instructions and/or data may be downloaded to the processor in electronic form, over a network, for example. Alternatively or additionally, the program instructions and/or data may be provided and/or stored on non-transitory tangible media, such as magnetic, optical, or electronic memory. Such program instructions and/or data, when provided to the processor, produce a machine or special-purpose computer, configured to perform the tasks described herein.

### Splitting the CSV File

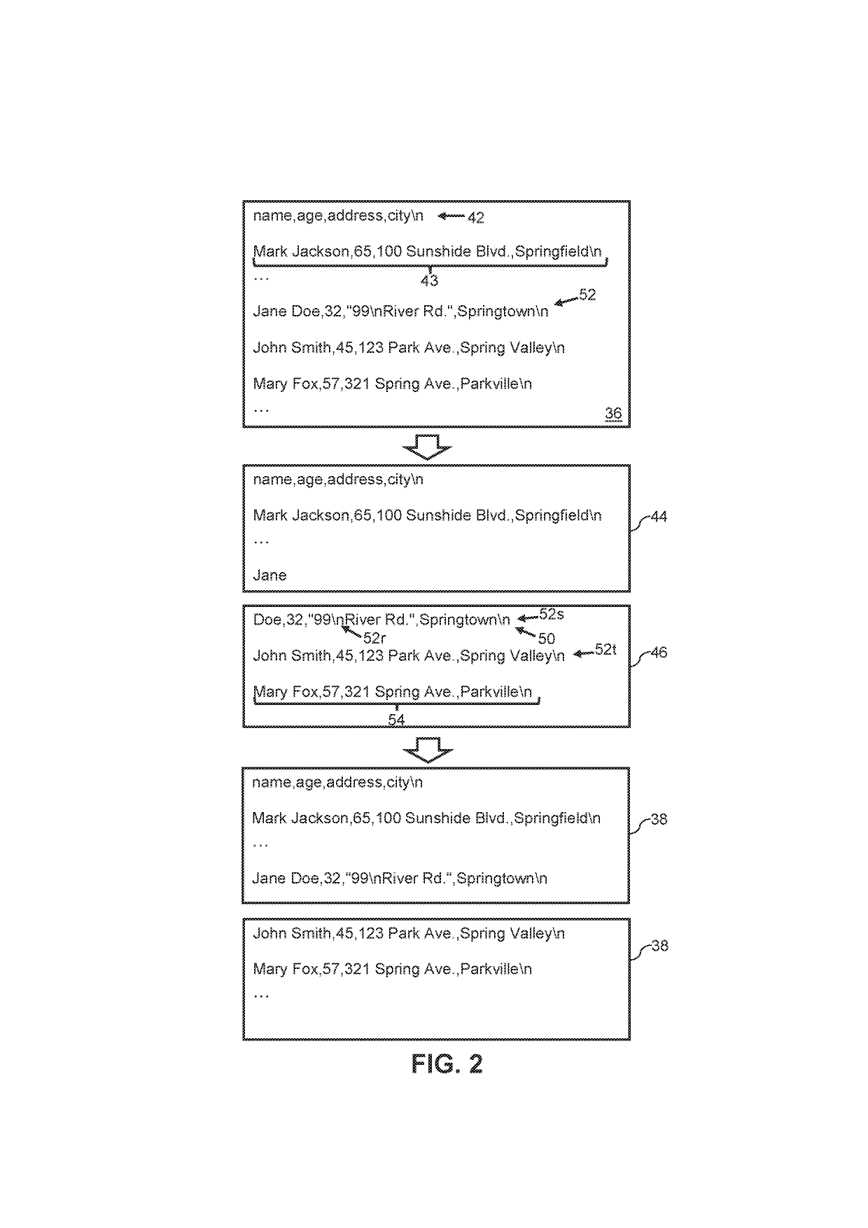

Reference is now made to FIG. 2, which is a schematic illustration of a splitting of an example CSV file 36 in accordance with some embodiments of the present disclosure.

By way of introduction, it is noted that each CSV file 36 contains a header row 42, which lists the fields in the file separated from each other by commas (or other delimiters), followed by one or more rows 43, each of which lists multiple elements separated from each other by commas (or other delimiters) and terminates with a newline character 52. (For cases in which the CSV file backs up a database table, rows 43 can also be referred to as “records,” in that each row represents a record from the table.) Barring an error, the number of elements in each row equals the number of fields.

In executing splitting function 34 (FIG. 1), processor 24 first identifies the number of fields in CSV file 36 by reading the header row 42 of the file. For example, for the CSV file shown in FIG. 2, the number of fields is four.

Next, the processor performs an initial splitting of the CSV file into a first part 44 and one or more subsequent parts 46 that follow first part 44. (FIG. 2 shows a single subsequent part 46.) Typically, the initial splitting is performed based on the size of the file, without regard to the content of the file; thus, for example, the file may be split in the middle of a row, e.g., in the middle of an element of a row as shown in FIG. 2. For example, in some embodiments, the processor splits the file such that the parts of the CSV file have approximately the same size as each other, this size being approximately equal to the desired approximate size of each portion 38. For example, given a CSV file of size ~120 GB and a desired portion size of ~40 GB, the processor may split the CSV file into three parts (including first part 44 and two subsequent parts 46), each of size ~40 GB. In some embodiments, “approximately the same size as each other” means that the maximum number of bytes amongst the parts is within 10 % of the minimum number of bytes amongst the parts. For example, if the smallest part is of size 40 GB, the largest part may be between 40 and 44 GB.

Next, the processor identifies respective terminating newline characters 50 in subsequent parts 46, by, for each of the subsequent parts, identifying, as the terminating newline character 50 in the subsequent part, a newline character 52 followed by one or more consecutive lines 54 that each has a number of elements equal to the number of fields. For this purpose, the processor considers each newline character 52 to mark the end of a respective line 54; in other words, a line, as defined by the processor, runs from a newline character to the next newline character.

For example, in some embodiments, the processor identifies a newline character 52 as the terminating newline character 50 in response to the newline character being followed by at least Y consecutive lines 54 that each has a number of elements equal to the number of fields, Y being a predefined integer greater than one. For example, the subsequent part 46 shown in FIG. 2 shows a newline character 52s followed by two consecutive lines 54 having four elements each, such that for Y = 2, the processor may identify newline character 52s as the terminating newline character 50.

Typically, the identified newline character 52 precedes any other newline character that is followed by at least Y consecutive lines 54 that each has the number of elements equal to the number of fields. For example, for the subsequent part 46 shown in FIG. 2, provided newline character 52s is followed by at least Y consecutive lines 54 that each has the number of elements equal to the number of fields, the processor would identify newline character 52s as the terminating newline character, even if the newline character 52t were to also satisfy this criterion.

Typically, to identify the terminating newline character 50 in each subsequent part 46, the processor iterates through the newline characters 52 in subsequent part 46 until the terminating newline character is found. For example, given the subsequent part 46 shown in FIG. 2 and assuming Y = 2, the processor may perform the following sequence of steps:
(a) Test newline character 52r:
(a.i) read next line: River Rd.”,Springtown
(a.ii) count number of elements in this line: 2
(a.iii) 2 ≠ number of fields; therefore, test next newline character
(b) Test newline character 52s:
(b.i) read next line: John Smith,45,123 Park Ave.,Spring Valley
(b.ii) count number of elements in this line: 4
(b.iii) 4 = number of fields; therefore, read next line
(b.iv) read next line: Mary Fox,57,321 Spring Ave.,Parkville
(b.v) count number of elements in this line: 4
(b.vi) 4 = number of fields; therefore, identify newline character 52s as the terminating newline character

Subsequently, the processor re-splits the file, following the terminating newline characters 50, into the multiple portions 38. In some embodiments, header row 42 is added to the top of each of the second through last portions.

For each of the consecutive lines 54, the number of elements equaling the number of fields indicates that the line likely spans a single row from beginning to end, which in turn indicates that the newline character being tested terminates a row. On the other hand, if a line does not meet this requirement, the newline character being tested is likely internal to a row, as in the case of newline character 52r in FIG. 2. Thus, advantageously, the requirement that the number of elements equal the number of fields helps avoid splitting the file in the middle of a row. In other words, identifying terminating newline characters 50 as described above, and then re-splitting the file following these newline characters, helps each portion 38 have a whole number of rows, even if one or more rows of the file include internal newline characters.

The setting of Y to a value greater than one, in accordance with some embodiments of the present disclosure, helps overcome rows in which an internal newline character happens to be followed by a line in which the number of elements equals the number of fields, given that it is unlikely for the CSV file to contain Y consecutive rows having this property. For example, it will be supposed that the CSV file includes two fields, and that one of the rows is as follows:
“\nMary,Jane&\nBob\n”,Smith\n
In this case, testing the first newline character in this row would proceed as follows:
   (i) read next line: Mary,Jane&
   (ii) count number of elements in this line: 2
   (iii) 2 = number of fields

Hence, if Y were only one, the newline character would be incorrectly identified as a terminating newline character. On the other hand, with Y ≥ 2, the newline character would not be identified as a terminating newline character, due to the next line (“Bob”) having only one element.

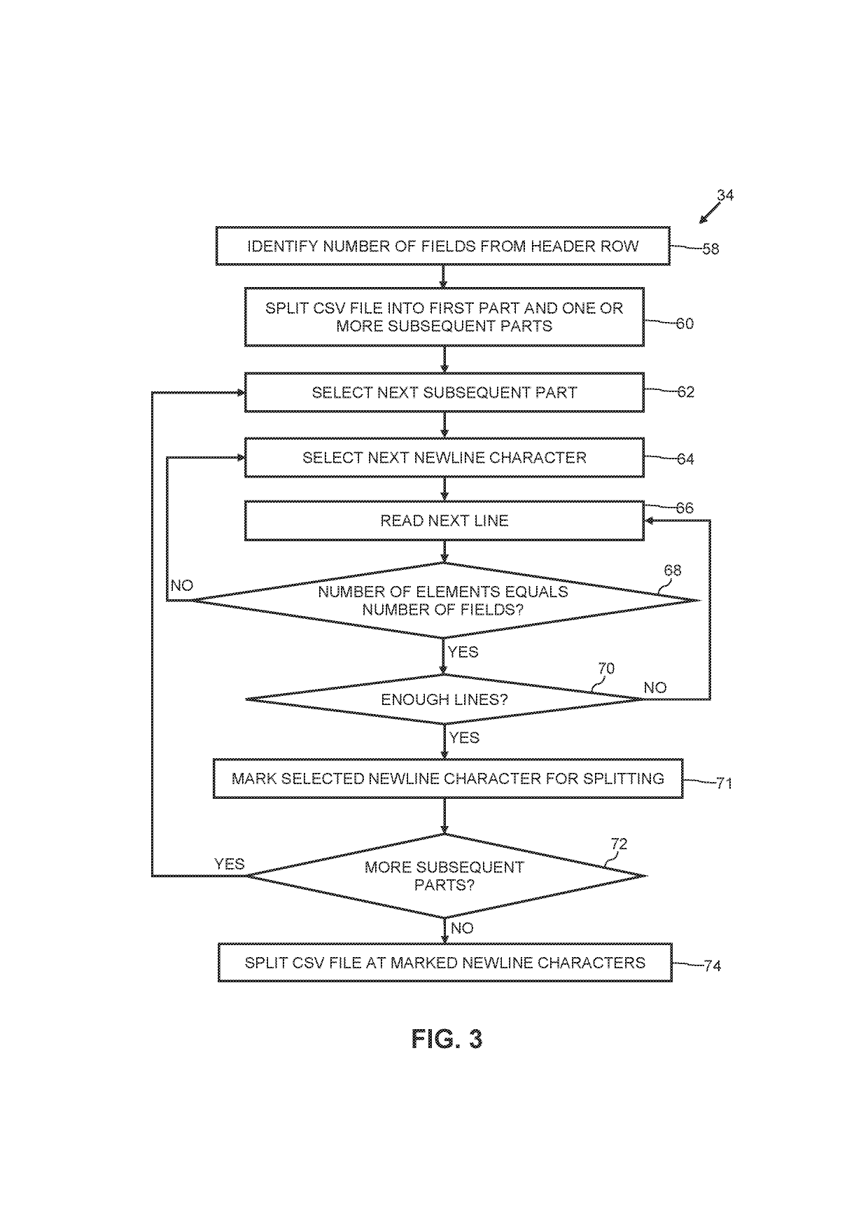

For further detail regarding the splitting of the CSV file, reference is now made to FIG. 3, which is a flow diagram for an algorithm implemented by splitting function 34, in accordance with some embodiments of the present disclosure.

In some embodiments, the execution of splitting function 34 begins with a header-reading step 58, at which the processor identifies the number of fields from the header row of the CSV file. Following header-reading step 58, the processor performs the initial (size-based) split of the CSV file, at a splitting step 60. In other embodiments, first splitting step 60 is performed prior to header-reading step 58.

Next, the processor iterates through the subsequent CSV parts, selecting each part at a part-selecting step 62. For each subsequent CSV part, the processor iterates through the newline characters, selecting each at a newline-character-selecting step 64, until a terminating newline character is found. In particular, after selecting each newline character, the processor reads the next line (i.e., reads all the characters to the next newline character) at a line-reading step 66. (For embodiments in which splitting function 34 is written in PYTHON^{TM}, line-reading step 66 may be implemented using the function file.readline().) Next, the processor checks, at a checking step 68, whether the number of elements in the line equals the number of fields. If not, the processor returns to newline-character-selecting step 64. Otherwise, the processor checks, at another checking step 70, whether enough consecutive lines with the required number of elements have been found. For example, for embodiments in which Y > 1 consecutive lines are required, the processor checks whether Y consecutive lines have been found. If not, the processor returns to line-reading step 66. Otherwise, the processor marks the selected newline character as a terminating newline character, at a marking step 71. The processor then checks, at another checking step 72, whether any subsequent parts remain. If yes, the processor returns to part-selecting step 62. Otherwise, the processor splits the CSV file at the marked newline characters, at another splitting step 74.

In some embodiments, alternatively to processing the subsequent parts of the CSV file in sequence as depicted in FIG. 3, the subsequent parts are processed in parallel to each other.

There is therefore provided, in accordance with some embodiments of the present disclosure, a method for processing a comma-separated values (CSV) file. The method includes identifying a number of fields in the file by reading a header row of the file, and splitting the file into a first part and one or more subsequent parts that follow the first part. The method further includes identifying respective terminating newline characters in the subsequent parts, by, for each of the subsequent parts, identifying, as the terminating newline character in the subsequent part, a newline character followed by one or more consecutive lines that each has a number of elements equal to the number of fields. The method further includes re-splitting the file, following the terminating newline characters, into multiple portions, and passing the portions to respective parallel processes.

In some embodiments, the parallel processes load data in the portions to a database.

In some embodiments, although at least one row of the file includes an internal newline character, re-splitting the file causes each of the portions to have a whole number of rows.

In some embodiments, the internal newline character is within quotation marks.

In some embodiments, the first part and subsequent parts include respective numbers of bytes, and splitting the file includes splitting the file such that a maximum of the numbers of bytes is within 10 % of a minimum of the numbers of bytes.

In some embodiments, identifying the newline character as the terminating newline character includes identifying the newline character as the terminating newline character in response to the newline character being followed by at least Y consecutive lines that each has the number of elements equal to the number of fields, Y being a predefined integer greater than one.

In some embodiments, the newline character precedes any other newline character that is followed by at least Y consecutive lines that each has the number of elements equal to the number of fields.

There is further provided, in accordance with some embodiments of the present disclosure, a computer software product including a tangible non-transitory computer-readable medium in which program instructions are stored. The instructions, when read by a processor, cause the processor to process a comma-separated values (CSV) file by identifying a number of fields in the file by reading a header row of the file, splitting the file into a first part and one or more subsequent parts that follow the first part, identifying respective terminating newline characters in the subsequent parts, by, for each of the subsequent parts, identifying, as the terminating newline character in the subsequent part, a newline character followed by one or more consecutive lines that each has a number of elements equal to the number of fields, re-splitting the file, following the terminating newline characters, into multiple portions, and passing the portions to respective parallel processes.

There is further provided, in accordance with some embodiments of the present disclosure, a system for processing a comma-separated values (CSV) file. The system includes a memory, configured to store program instructions, and a processor, configured to, by executing the program instructions, identify a number of fields in the file by reading a header row of the file, split the file into a first part and one or more subsequent parts that follow the first part, identify respective terminating newline characters in the subsequent parts, by, for each of the subsequent parts, identifying, as the terminating newline character in the subsequent part, a newline character followed by one or more consecutive lines that each has a number of elements equal to the number of fields, re-split the file, following the terminating newline characters, into multiple portions, and pass the portions to respective parallel processes.

It will be appreciated by persons skilled in the art that the present disclosure is not limited to what has been particularly shown and described hereinabove. Rather, the scope of the present disclosure includes both combinations and subcombinations of the various features described hereinabove, as well as variations and modifications thereof that are not in the prior art, which would occur to persons skilled in the art upon reading the foregoing description.

1. A method for processing a comma-separated values (CSV) file, the method comprising:
identifying a number of fields in the file by reading a header row of the file;
splitting the file into a first part and one or more subsequent parts that follow the first part;
identifying respective terminating newline characters in the subsequent parts, by, for each of the subsequent parts, identifying, as the terminating newline character in the subsequent part, a newline character followed by one or more consecutive lines that each has a number of elements equal to the number of fields;
re-splitting the file, following the terminating newline characters, into multiple portions; and
passing the portions to respective parallel processes.

2. The method according to claim 1, wherein the parallel processes load data in the portions to a database.

3. The method according to claim 1, wherein, although at least one row of the file includes an internal newline character, re-splitting the file causes each of the portions to have a whole number of rows.

4. The method according to claim 3, wherein the internal newline character is within quotation marks.

5. The method according to claim 1, wherein the first part and subsequent parts include respective numbers of bytes, and wherein splitting the file comprises splitting the file such that a maximum of the numbers of bytes is within 10% of a minimum of the numbers of bytes.

6. The method according to claim 1, wherein identifying the newline character as the terminating newline character comprises identifying the newline character as the terminating newline character in response to the newline character being followed by at least Y consecutive lines that each has the number of elements equal to the number of fields, Y being a predefined integer greater than one.

7. The method according to claim 6, wherein the newline character precedes any other newline character that is followed by at least Y consecutive lines that each has the number of elements equal to the number of fields.

8. A computer software product comprising a tangible non-transitory computer-readable medium in which program instructions are stored, which instructions, when read by a processor, cause the processor to process a comma-separated values (CSV) file by:
identifying a number of fields in the file by reading a header row of the file,
splitting the file into a first part and one or more subsequent parts that follow the first part,
identifying respective terminating newline characters in the subsequent parts, by, for each of the subsequent parts, identifying, as the terminating newline character in the subsequent part, a newline character followed by one or more consecutive lines that each has a number of elements equal to the number of fields,
re-splitting the file, following the terminating newline characters, into multiple portions, and
passing the portions to respective parallel processes.

9. The computer software product according to claim 8, wherein the parallel processes load data in the portions to a database.

10. The computer software product according to claim 8, wherein, although at least one row of the file includes an internal newline character, re-splitting the file causes each of the portions to have a whole number of rows.

11. The computer software product according to claim 10, wherein the internal newline character is within quotation marks.

12. The computer software product according to claim 8, wherein the first part and subsequent parts include respective numbers of bytes, and wherein splitting the file includes splitting the file such that a maximum of the numbers of bytes is within 10% of a minimum of the numbers of bytes.

13. The computer software product according to claim 8, wherein identifying the newline character as the terminating newline character includes identifying the newline character as the terminating newline character in response to the newline character being followed by at least Y consecutive lines that each has the number of elements equal to the number of fields, Y being a predefined integer greater than one.

14. The computer software product according to claim 13, wherein the newline character precedes any other newline character that is followed by at least Y consecutive lines that each has the number of elements equal to the number of fields.

15. A system for processing a comma-separated values (CSV) file, the system comprising:
a memory, configured to store program instructions; and
a processor, configured to, by executing the program instructions:
identify a number of fields in the file by reading a header row of the file,
split the file into a first part and one or more subsequent parts that follow the first part,
identify respective terminating newline characters in the subsequent parts, by, for each of the subsequent parts, identifying, as the terminating newline character in the subsequent part, a newline character followed by one or more consecutive lines that each has a number of elements equal to the number of fields,
re-split the file, following the terminating newline characters, into multiple portions, and
pass the portions to respective parallel processes.

16. The system according to claim 15, wherein the parallel processes load data in the portions to a database.

17. The system according to claim 15, wherein, although at least one row of the file includes an internal newline character, re-splitting the file causes each of the portions to have a whole number of rows.

18. The system according to claim 17, wherein the internal newline character is within quotation marks.

19. The system according to claim 15, wherein the first part and subsequent parts include respective numbers of bytes, and wherein the processor is configured to split the file such that a maximum of the numbers of bytes is within 10% of a minimum of the numbers of bytes.

20. The system according to claim 15, wherein the processor is configured to identify the newline character as the terminating newline character in response to the newline character being followed by at least Y consecutive lines that each has the number of elements equal to the number of fields, Y being a predefined integer greater than one.
